(19) United States
(12) Patent Application Publication
(10) Pub. No.: US 2025/0376058 A1
(43) Pub. Date: Dec. 11, 2025

(54) POSITIONING UNIT FOR A CHARGING STATION, AND CONTACTING METHOD

(71) Applicant: Schunk Transit Systems GmbH, Wettenberg (DE)

(72) Inventors: Holger Leib, Heuchelheim (DE); Timo Staubach, Herbstein (DE)

(21) Appl. No.: 18/879,804

(22) PCT Filed: Jun. 28, 2022
(86) PCT No.: PCT/EP2022/067732

§ 371 Date: Dec. 30, 2024

(51) Int. Cl. B60L 53/35; B60L 53/16

(52) U.S. Cl. CPC B60L 53/35; B60L 53/16; B60L 2200/18

(57) ABSTRACT

The invention relates to a positioning unit (12) and a method for establishing an electrically conductive connection between a stationary charging station (10) and a vehicle (24), in particular an electric bus or the like, a contact device (15) having an electric charging contact (19) of the positioning unit being movable in relation to a charging-contact surface (21) and being contactable therewith by means of the positioning unit, the positioning unit having a positioning device (13) and a drive device (14) for driving the positioning device, the charging contact being able to be positioned between a contact position (18) for transmitting power and a retracted position for interrupting power transmission by means of the positioning device, the positioning unit comprising a cover device (25) having an apron (26), the apron surrounding at least sections, preferably the entirety of, the contact device and being movable towards the contact position.

The invention relates to a positioning unit and a method for establishing an electrically conductive connection between a stationary charging station and a vehicle, in particular an electric bus or the like, a contact device having an electric charging contact of the positioning unit being movable in relation to a charging-contact surface and being contactable therewith by means of the positioning unit, the positioning unit having a positioning device and a drive device for driving the positioning device, the charging contact being able to be positioned between a contact position for transmitting power and a retracted position for interrupting power transmission by means of the positioning device.

Such positioning units and methods are known from the state of the art and are regularly used in electrically powered vehicles. These vehicles can be electric busses, but in principle also other vehicles, such as a train, a streetcar or a ferry, which are not permanently electrically connected to a catenary or the like. In these vehicles, an electric energy storage is charged by a charging station when the journey is interrupted at a stop or a vehicle depot. The vehicle is electrically connected to the charging station at the vehicle depot, the energy storage of the vehicle being charged, for example overnight.

To establish an electrically conductive connection between the vehicle and the charging station, a contact device is used which is mounted and/or positioned on the positioning unit above the vehicle at a parking space of the vehicle at the vehicle depot or at a bus stop. A charging contact of the contact device is then moved towards a charging-contact surface on a roof of the vehicle and an electrical connection is established by means of the positioning unit. For instance, a contact device can have at least four charging contacts, two charging contacts then being able to be regularly used for transmitting power transmission, one charging contact as a ground contact and another charging contact for transferring data. Since the energy storage of the vehicle is charged using a comparatively high voltage, for example 750 volts or more, and using a comparatively high current, electrical safety during a charging process is of great importance. A positioning unit is known, for example, from DE 10 2015 217 380 A1.

If the charging station is located outside of closed rooms, for example in an outdoor area, the problem regularly arises that the charging station and the vehicle are exposed to weather conditions. In addition to heavy rains, low temperatures, freezing rain or snowfall can make the charging process more difficult or even completely impossible. In particular, leak-age currents or a voltage flashover can occur in an area of the charging contacts as a result of moisture. If a charging process lasts for several hours, the positioning unit can freeze or become snowed in, particularly in icy rain or snow. For example, the positioning unit can then no longer be moved to the retracted position due to a snow load. This may mean that the positioning unit has to be de-iced manually in order to ensure that it can function correctly.

It is therefore the object of the invention to propose a positioning unit and a method for establishing an electrically conductive connection between a stationary charging station and a vehicle, both of which allow safely charging a vehicle in a cost-efficient manner.

This object is attained by a positioning unit having the features of claim 1, a charging station having the features of claim 17, a method having the features of claim 18 and a use having the features of claim 19.

In the positioning unit according to the invention for establishing an electrically conductive connection between a stationary charging station and a vehicle, in particular an electric bus or the like, a contact device having an electric charging contact of the positioning unit is movable in relation to a charging-contact surface and being contactable therewith by means of the positioning unit, the positioning unit having a positioning device and a drive device for driving the positioning device, the charging contact being able to be positioned between a contact position for transmitting power and a retracted position for interrupting power transmission by means of the positioning device, the positioning unit comprising a cover device having an apron, the apron surrounding at least sections, preferably the entirety, of the contact device and being movable towards the contact position.

The positioning unit is therefore a component of a stationary charging station for an electrically powered vehicle and is used to move the electric charging contact(s) onto a charging-contact surface of the vehicle, which is disposed on a vehicle roof, and to electrically contact it therewith. The movement of the charging contact(s) onto the corresponding charging-contact surface is carried out by means of the positioning unit, which is disposed above the vehicle on a roof structure. The charging contact(s) is/are disposed at a lower end of the positioning unit and can be moved from an upper retracted position to a lower contact position for transmitting power and/or contacting the charging-contact surfaces. This movement of the charging contact(s) takes place by means of the positioning device, which can be actuated and/or driven using the drive device.

According to the invention, it is intended that the positioning unit comprises the cover device, which has at least one apron. This apron can surround at least sections of the contact device, which is disposed on the positioning device and has the charging contact(s). Furthermore, the cover device is designed in such a manner that the apron is movable towards the contact position. This makes it possible to cover the positioning device, the contact device and/or the charging contact(s) at least to some extent when they are in the contact position. In particular, the apron can be lowered in a vertical direction to such an extent that the positioning device, the contact device and/or the charging contact(s) are protected from excessive moisture, such as rain falling at an angle, snowfall or the like. In this context, it is particularly advantageous if the cover device completely surrounds the positioning unit and/or the contact device in order to protect it from weather conditions form all sides during a charging process. In principle, however, it is also possible for the cover device to be oriented solely towards one direction of the weather. Furthermore, the cover device can be designed in such a manner that it can be used as required and according to weather conditions. In addition, the cover device serves to protect the positioning unit from un-authorized access, for example from objects thrown at the positioning unit or people on the roof of the vehicle. This also makes it possible to increase the charging voltage and thus enable even faster charging of the vehicle.

The apron can be positioned in the contact position in a direction transverse to a contact plane of the charging contact. Depending on the position of the vehicle, the contact plane is usually horizontal. The apron can then be moved transversely and/or orthogonally to the contact plane. When the charging contact is in the contact position, the apron can be lowered towards the contact plane, for example in such a manner that the apron is positioned adjacent to the charging-contact surface or resting thereon. In particular, the area where the charging contact rests on the charging-contact surface can then be completely or almost completely shielded by the apron.

The apron can be formed by a roller blind, a venetian blind, a concertina cover, a folding blind or a slatted apron. The roller blind can be mounted to the positioning unit in a particularly space-saving manner and is available at low cost. The roller blind can also be made of a synthetic, durable material and/or textile fabric. The fabric can be flexible and partially transparent, so that the fabric is air-permeable in the manner of a marquise and can give way in the wind. A venetian blind can also be in-stalled in a space-saving manner and can also be adapted to any weather conditions by tilting the slats. A concertina cover can be made from a variety of materials and is suitable for tightly enclosing the contact device. In addition, a concertina cover is particularly stable. The cover device can be made even more stable if the apron is a slatted apron. The slated apron can be made from a variety of slats which interlock telescopically.

The cover device can have a cover element has a cover element made of an individual apron or a plurality of aprons. The single apron can be a concertina cover or a simple roller blind, for example. The plurality of aprons can be disposed in such a manner that the contact device is surrounded by the aprons. For example, four aprons, such as roller blinds, can be disposed such that their lateral edges essentially abut against each other.

The cover element can have a round, oval, square or rectangular cross section. A cross section of the cover element is understood here as a section transverse to a direction of movement of the apron(s). Depending on the shape and/or design of the positioning device and the contact device, the cross section can be selected such that the positioning device together with the contact device is tightly surrounded by the cover element.

The cover element can have a frame at a lower end, the frame being able to surround the positioning device together with the contact device. The frame can be disposed directly at the lower end or adjacent to the lower end and can be formed by a rigid profile, for example. Deformation of the cover element in the area of the lower end can thus be prevented. The cover element can then also not come into direct contact with the charging contacts in an uncontrolled manner. At the same time, the apron can be tensioned vertically by the frame and/or its weight, so that the apron is only slightly deformed by wind or the like. If several aprons are used, the frame can ensure they are positioned evenly in the direction of the contact positions.

The cover element can be detachably connected in such a manner to the positioning device or the contact device at a lower end that the cover device can follow a movement of the charging contact. Thus, it may be intended that the cover device can be connected to the positioning device or the contact device in the area of the positioning device or the contact device, for example by means of hooks or another type of suitable connection easy to establish and release. This enables the cover device to be guided by means of the positioning device or the contact device when the positioning device and/or the contact device is moved from the retracted position to the contact position and back. No special actuation of the cover device by a specially designed drive is required. However, it is advantageous if a mechanical element is provided for retrieving the apron(s). In the case of a roller blind, for example, this can be a spring. The cover element can then be easily connected to the positioning device or the contact device by an operator of the vehicle as required, for example if a longer charging process is planned in foreseeably poor weather conditions. It is also possible for the positioning device or the contact device to be connected to the lower end of the cover element in an auto-mated manner at the request of the operator.

The cover device can form a roof which at least partially, preferably entirely, spans the positioning device together with the contact device. The roof can have any desired roof shape and be designed in such a manner that the positioning device together with the contact device is protected against precipitation. The roof can also be formed by a mast and/or cantilever to which the positioning unit is attached. The cover device and/or apron can be mounted on the edges of the roof. The cover device is then also spanned by the roof. The cover device can entirely surround the contact device in a horizontal retracted plane when in the retracted position. The horizontal retracted plane is understood to be a plane where the charging contacts are located in the retracted position of the positioning device. The contact device and/or the charging contact is then protected against weather conditions acting laterally on the positioning unit when the positioning device is in the retracted position.

The cover device can have a hood which has a circumferential wall and whose circumference surrounds the positioning device together with the contact device, the apron being disposed on an inner side of the hood. The hood can then simultaneously form a roof, which is disposed at an upper end of the cover device. The circumferential wall can be essentially vertical and entirely surround the contact device in the retracted plane. The apron(s) can be disposed on the inner side of the hood and/or the corresponding wall. This makes it possible to protect the apron in a retracted position against weather conditions as well.

The cover device can have a drive element by means of which the apron is able to be positioned between the contact position and the retracted position. The drive element can comprise an electromotive drive which can interact with a spring, a gearbox, lever gear or the like, for example. For instance, a slatted apron or a concertina cover can be easily actuated by means of scissor mechanism. A roller blind or a venetian blind can be raised or lowered by means of a rotary drive.

The drive element can have a control element and an electric motor which can be controllable by means of the control element. The control element can cause the cover device to be lowered and raised, for example in parallel with a movement of the positioning device or in response to an external request from an operator, for example via a radio connection to the corresponding vehicle. The drive element can also have a plurality of electric motors, depending on how many aprons the cover device comprises. The control element can also control the speed at which the apron is lowered or raised.

Advantageously, the drive element can have a position sensor and/or a path sensor, by means of which an extraction path of the apron can be determinable, and/or a force sensor, by means of which a contact force can be determinable. For instance, the position sensor can be used to detect the position of the charging-contact surface so that a specific extraction path can be determined by the drive element depending on the height of the vehicle in question. The extraction path traveled can in turn be measured using a path sensor. For instance, the path sensor can be a simple rotary encoder on a roller blind. The force sensor can be used to measure a contact force when a lower end of the apron and/or the drive device abuts against the roof of a vehicle or the charging-contact surface. The force sensor can also be used to measure a contact force in the retracted position so that the retracted position of the apron can be detected. The force sensor can thus be used to switch off a drive of the drive element.

The drive device can have a displacement drive for enacting a displacement force acting on the positioning device and a spring element mechanically interacting with the displacement drive. The spring element can be formed by one or more springs. The displacement drive can be a pneumatic, hydraulic or electromechanical drive which acts on the positioning device and can move it into the contact position and optionally into the retracted position. The spring element can be used to exert a de-fined contact force on the corresponding charging-contact surfaces. The spring element can also be designed such that the positioning device is moved to the retracted position by means of a spring force if the displacement drive fails.

The contact device can have two charging contact carriers with at least two charging contacts disposed on them. The positioning unit can then have a total of four charging contacts. Two of the charging contacts can be used for power transmission, one charging contact as a ground contact and another charging contact for data transfer.

The charging contacts can be connected to each other via a linkage of the contact device by means of at least one connective rod each for connecting two charging contacts and by means of at least one carrier rod disposed transversely to the connective rods in order to connect the charging-contact carriers to each other. The linkage then makes it possible to distribute a contact force evenly to all charging contacts and to exert it on the respective charging-contact surfaces via the charging contacts. The linkage can also be used to compensate movement of the vehicle during a charging process.

The charging station according to the invention comprises a mast, a cantilever or a bridge and a positioning unit disposed above and on a vehicle. Further advantageous embodiments of the charging station are shown in the feature descriptions of the dependent claims referring to device claim 1.

In the method according to the invention for establishing an electrically conductive connection between a stationary charging station and a vehicle, in particular an electric bus or the like, a contact device having an electric charging contact of a positioning unit is moved in relation to a charging-contact surface and being contacted therewith by means of the positioning unit, a positioning device of the positioning unit being driven by a drive device of the positioning unit, the charging contact being positioned between a contact position for transmitting power and a retracted position for interrupting power transmission by means of the positioning device, an apron of a cover device of the positioning unit surrounding at least sections, preferably the entirety, of the contact device and is moved towards the contact position. With regard to the advantages of the method according to the invention, reference is made to the description of the advantages of the positioning unit according to the invention. Further advantageous embodiments of the method result from the feature descriptions of the independent claims referring to device claim 1.

According to the invention, a cover device having an apron is used for covering a contact device of a positioning unit for establishing an electrically conductive connection between a stationary charging station and a vehicle, in particular an electric bus or the like, the contact device having an electric charging contact of the positioning unit being movable in relation to a charging-contact surface and being contactable therewith by means of the positioning unit, the positioning unit having a positioning device and a drive device for driving the positioning device, the charging contact being able to be positioned between a contact position for transmitting power and a retracted position for interrupting power transmission by means of the positioning device, the apron surrounding at least sections, preferably the entirety, of the contact device and being movable towards the contact position. Further advantageous embodiments of the use result from the feature descriptions of the independent claims referring back to device claim 1.

In the following, preferred embodiments of the invention are described in more detail with reference to the enclosed drawings.

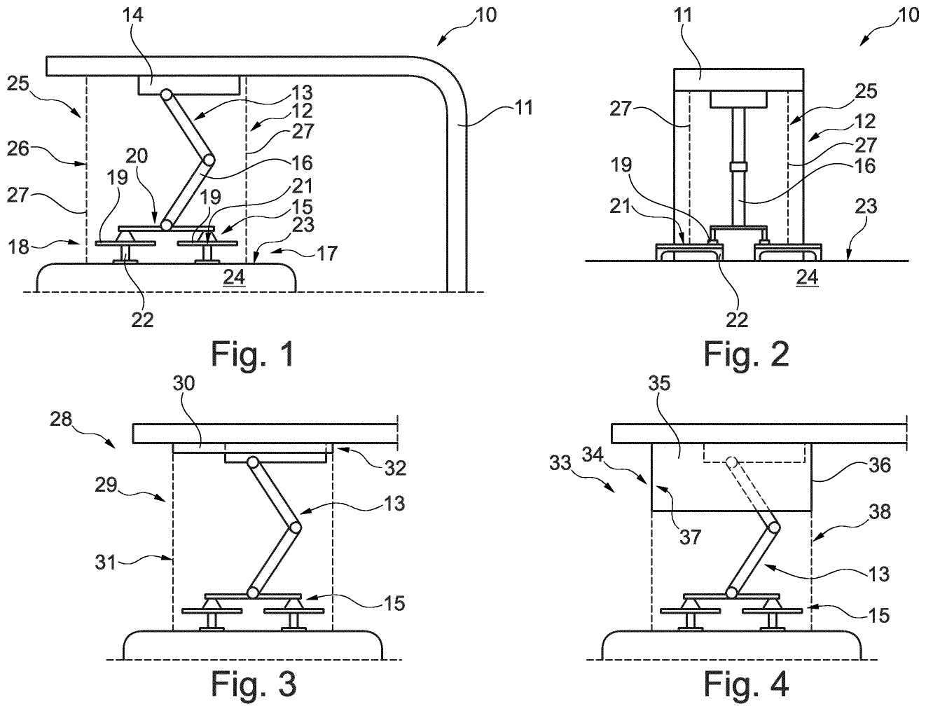

FIG. 1 shows a lateral view of a first embodiment of a charging station with a vehicle.

FIG. 2 shows a front view of the charging station with the vehicle from FIG. 1.

FIG. 3 shows a lateral view of a second embodiment of a charging station.

FIG. 4 shows a lateral view of a third embodiment of a charging station.

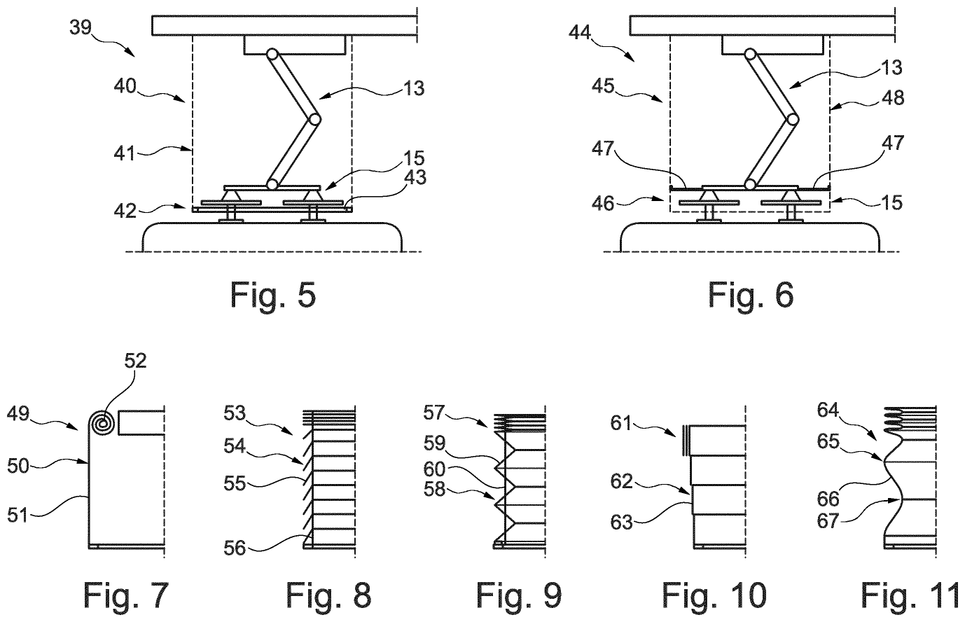

FIG. 5 shows a lateral view of a fourth embodiment of a charging station.

FIG. 6 shows a lateral view of a fifth embodiment of a charging station.

FIG. 7 shows a sectional view of a first embodiment of an apron.

FIG. 8 shows a sectional view of a second embodiment of an apron.

FIG. 9 shows a sectional view of a third embodiment of an apron.

FIG. 10 shows a sectional view of a fourth embodiment of an apron.

FIG. 11 shows a sectional view of a fifth embodiment of an apron.

A combined view of FIGS. 1 and 2 shows a charging station 10 with a mast 11 and a positioning unit 12 disposed thereon. The positioning unit 12 is shown here only schematically and comprises a positioning device 13, a drive device 14 and a contact device 15. The positioning device 13 has a hinged bracket 16, at the lower end 17 of which the contact device 15 is disposed. The hinged bracket 16 can be moved from a retracted position to the contact position 18 shown here and back by means of the drive device 14. On the contact device 15, four charging contacts 19 are disposed on a linkage 20 of the contact device 15 and, in the illustration shown here, are electrically contacted with charging-contact surfaces 21 of contact rails 22, which are disposed on a roof 23 of a vehicle 24 only partially shown here.

The positioning unit 12 also comprises a cover device 25, which is only shown schematically here. The cover device 25 in turn comprises an apron 26, which entirely surrounds the contact device 15 and can be moved towards the contact position 18. The apron 26 can also be moved so far upwards that it is located exclusively in an area of the drive device 14 essentially in a retracted position. A basic range of movement of the apron is shown in FIGS. 1 and 2 with a dashed line 27.

FIG. 3 shows an embodiment of a positioning unit 28 in which a cover device 29 is formed together with a roof 30. The roof 30 completely spans the positioning device 13 together with the contact device 15. Furthermore, the cover device 29 has an apron 31 which is disposed at the respective edges 32 of the roof 30.

FIG. 4 shows an embodiment of a positioning unit 33 in which a cover device 34 has a hood 35. The hood 35 has a circumferential wall 36, which surrounds the positioning device 13 with the contact device 15. An apron 38 of the cover device 34 is disposed on an inner side 37 of the hood 35 each.

FIG. 5 shows a positioning unit 39 with a cover device 14 with in turn an apron 41. In particular, a frame 43 is disposed here at a lower end 42 of the apron 41, the frame 43 being able to be lowered or raised together with the apron 41. The frame 43 serves to stabilize the apron 41 and to tighten and/or generate tension in the apron 41 as a result of its weight.

FIG. 6 shows a positioning unit 44 with a cover device 45 in which connective elements 47 are fastened to a lower end 46 and couple the contact device 15 with an apron 48 of the cover device 45. By lowering and/or raising the contact device 15 above the positioning device 13, the apron 48 can also be lowered and raised.

FIG. 7 shows an embodiment of an apron 49 according to which the apron 49 is designed as a roller blind 50. The roller blind 50 is formed from a web 51 which can be wound onto and/or unwound from a reel 52 of the roller blind 50.

FIG. 8 shows an apron 53 formed by a venetian blind 54. The venetian blind 54 consists of slats 55 and cords 56 connecting the slats 55.

FIG. 9 shows an apron 57 formed by a folding blind 58. Here, a folded web 59 of the folding blind 58 can be lowered and raised by means of a cord 60.

An apron 61 shown in FIG. 10 is formed by a slatted apron 62. The slatted apron 62 consists of slats 63, which are disposed vertically and can be pushed into one another in the manner of a telescope. The slatted apron 62 can be lowered or raised using cords not shown here or a scissor mechanism.

Another embodiment of an apron 64 is shown in FIG. 11, where the apron 64 is formed by a concertina cover 65. The concertina cover 65 consists here of a web 66, which has a substantially predetermined shape with horizontal folds 67. The web 66 can, for example, be formed from an elastic material.

The positioning units as described in FIGS. 1 to 6 can each have one or more of the aprons described in FIGS. 7 to 11.

1. A positioning unit (12, 28, 33, 39, 44) for establishing an electrically conductive connection between a stationary charging station (10) and a vehicle (24), a contact device (15) having an electric charging contact (19) of the positioning unit being movable in relation to a charging-contact surface (21) and being contactable therewith by means of the positioning unit, the positioning unit having a positioning device (13) and a drive device (14) for driving the positioning device, the charging contact being able to be positioned between a contact position (18) for transmitting power and a retracted position for interrupting power transmission by means of the positioning device, wherein the positioning unit comprises a cover device (25, 29, 34, 40, 45) having an apron (26, 31, 38, 41, 48, 53, 57, 61, 64), the apron surrounding at least sections of the contact device and being movable towards the contact position.

2. The positioning unit according to claim 1, wherein the apron (26, 31, 38, 41, 48, 53, 57, 61, 64) is able to be positioned in the contact position (18) in a direction transverse to a contact plane of the charging contact (19).

3. The positioning unit according to claim 1, wherein the apron (26, 31, 38, 41, 48, 53, 57, 61, 64) is formed by a roller blind (50), a venetian blind (54), a concertina cover (65), a folding blind (58) or a slatted apron (62).

4. The positioning unit according to claim 1, wherein the cover device (25, 29, 34, 40, 45) has a cover element made of an individual apron (26, 31, 38, 41, 48, 53, 57, 61, 64) or a plurality of aprons (48, 53, 57, 61, 64).

5. The positioning unit according to claim 4, wherein the cover element has a round, oval, square or rectangular cross section.

6. The positioning unit according to claim 4, wherein the cover element has a frame (43) at a lower end (42), the frame surrounding the positioning device (13) together with the contact device (15).

7. The positioning unit according to claim 4, wherein the cover element is detachably connected in such a manner to the positioning device (13) or the contact device (15) at a lower end (17, 46) that the cover device follows a movement of the charging contact (19).

8. The positioning unit according to claim, wherein the cover device (25, 29, 34, 40, 45) forms a roof (30) which at least partially spans the positioning device (13) together with the contact device (15).

9. The positioning unit according to claim, wherein the cover device (29) entirely surrounds the contact device (15) in a horizontal retraction plane when in the retracted position.

10. The positioning unit according to claim 9, wherein the cover device (34) has a hood (35) which has a circumferential wall and whose circumference surrounds the positioning device together with the contact device, the apron being disposed on an inner side of the hood.

11. The positioning unit claim 1, wherein the cover device (25, 29, 34, 40, 45) has a drive element by means of which the apron (26, 31, 38, 41, 48, 53, 57, 61, 64) is able to be positioned between the contact position (18) and the retracted position.

12. The positioning unit according to claim 11, wherein the drive element has a control element and an electric motor which is controllable by means of the control element.

13. The positioning unit according to claim 11, wherein the drive element has a position sensor or a path sensor, by means of which an extraction path of the apron (26, 31, 38, 41, 48, 53, 57, 61, 64) is determinable, and/or a force sensor, by means of which a contact force is determinable.

14. The positioning unit according to claim 1, wherein the drive device has a displacement drive for enacting a displacement force acting on the positioning device (13) and a spring element mechanically interacting with the displacement drive.

15. The positioning unit according to claim 1, wherein the contact device (15) has two charging-contact carriers having two charging contacts (19) disposed thereon.

16. The positioning unit according to claim 15, wherein the charging contacts (19) are connected to each other via a linkage (20) of the contact device (15) by means of at least one connective rod each for connecting two charging contacts and by means of at least one carrier rod disposed transversely to the connective rods in order to connect the charging-contact carriers to each other.

17. A charging station (10) having a mast (11), a cantilever or a bridge and a positioning unit (12, 28, 33, 39, 44) disposed above and on a vehicle (24) and according to claim 1.

18. A method for establishing an electrically conductive connection between a stationary charging station (10) and a vehicle (24), a contact device (15) having an electric charging contact (19) of a positioning unit (12, 28, 33, 39, 44) being moved in relation to a charging-contact surface (21) and being contacted therewith by means of the positioning unit, a positioning device (13) of the positioning unit being driven by a drive device (14) of the positioning unit, the charging contact being positioned between a contact position (18) for transmitting power and a retracted position for interrupting power transmission by means of the positioning device,
wherein an apron (26, 31, 38, 41, 48, 53, 57, 61, 64) of a cover device (25, 29, 34, 40, 45) of the positioning unit surrounds at least sections of the contact device and is moved towards the contact position.

19. A method of covering by using a cover device (25, 29, 34, 40, 45) having an apron (26, 31, 38, 41, 48, 53, 57, 61, 64) for covering a contact device (15) of a positioning unit (12, 28, 33, 39, 44) for establishing an electrically conductive connection between a stationary charging station (10) and a vehicle (24), the contact device having an electric charging contact (19) of the positioning unit being movable in relation to a charging-contact surface (21) and being contactable therewith by means of the positioning unit, the positioning unit having a positioning device (13) and a drive device (14) for driving the positioning device, the charging contact being able to be positioned between a contact position (18) for transmitting power and a retracted position for interrupting power transmission by means of the positioning device, the apron surrounding at least sections of the contact device and being movable towards the contact position.

20. The positioning unit of claim 1, the apron surrounding the entirety of the contact device.
